(19) United States
(12) Patent Application Publication
(10) Pub. No.: US 2004/0231898 A1
(43) Pub. Date: Nov. 25, 2004

(54) Cooling system for an automotive drive unit

(76) Inventors: Manfred Hochkoenig, Moeglingen (DE); Thomas Wolf, Riedstadt (DE); Bernd Sebastian, Renningen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/785,401

(22) Filed: Feb. 25, 2004

(30) Foreign Application Priority Data
Feb. 26, 2003 (DE) 103 08 084.8

(51) Int. Cl. B60K 11/00

(52) U.S. Cl. 180/68.1

(57) ABSTRACT

To cool an automotive drive system mounted in the rear of the vehicle, air inlet openings are provided in the covering panel part of the undercarriage, creating through the influx of air a cold air layer zone around the transmission and the bottom of the engine, displacing a hot air layer zone of the engine, which is layered above the cold air, outward through air outlets.

This application claims the priority of German application 103 08 084.8, filed Feb. 26, 2003, the disclosure of which is expressly incorporated by reference herein.

### BACKGROUND AND SUMMARY OF THE INVENTION

This invention relates to a cooling system of an automotive drive unit, in particular for a drive unit such as an internal combustion engine situated in a rear end of a vehicle with a respective transmission, comprising a covering panel part situated beneath the drive unit as part of a covering undercarriage of a vehicle superstructure.

German Patent Document DE 37 16 701 A1 discloses an aerodynamically designed covering panel part for an underside of a vehicle. A holding element is provided to cool specifically the units and/or running gear parts situated above the covering panel part. This element is of such a shape that the cooling air entering through an inlet opening is directed toward the units and/or the parts of the running gear.

One object of this invention is to create an improved cooling system for an automotive drive unit with which an effective cooling of the internal combustion engine including the transmission system can be achieved in a rear engine of a vehicle.

This object is achieved according to this invention by having a warmer air layer zone formed on an engine side layered above oncoming air supplied to a transmission case through air inlets in the covering panel part of the undercarriage, forming a cold air layer zone. A temperature interface develops between the cold air and the warmer air layer zones, temporarily running approximately in an area of an upper border of the transmission case and through a lower partial area of an engine housing which is connected to the transmission case. Other advantageous features are specified in the dependent claims.

Advantages achieved with this invention include achieving a two-zone temperature stratification, i.e., a hot-cold stratification due to a slow-flow air movement over a broad area while driving, and bringing the environment of the units to be cooled to a lower temperature level over a large volume. This is achieved by layering a hotter air layer zone formed on the engine side above a transmission case with oncoming airflow supplied to a transmission housing through air inlets in the covering panel part of an undercarriage to form a cold air layer zone. A so-called temperature interface is formed between the two zones, running temporarily approximately in the area of the upper border of the transmission case and through a lower partial area of the engine housing connected to the transmission case.

In order to introduce a large volume of air per unit of time into the environment of the units to be cooled, and not only air at a high velocity, air inlet openings are provided on the front side (as seen in the direction of travel) of the installation space of the units in the covering panel part of the undercarriage beneath the transmission case and air outlet openings are provided on the rear side beneath the engine housing in the installation space of the units. The air inlet openings are therefore arranged over a large area in the covering panel part in a front region beneath the transmission case, and the air outlet openings are arranged in a rear area of the engine housing.

At least one other air inlet opening is designed as an oncoming flow channel and is situated in the covering panel part of the undercarriage behind the air inlet openings—with respect to the direction of travel—and pointed directly toward a differential of the transmission. This advantageously permits a transmission element of the system, which is under a high heat burden, to be additionally exposed to a cooling air stream so that no hot spots can develop.

To influence the hot air layer zone around the engine in a controlled manner, a scavenging air blower is provided for the engine at the top in the installation space of the units. At low driving speeds, the flow through the scavenging air blower is dominant, forcing cold compressed air from the outside into the installation space. Heat generation in the transmission area is low and thus the cooling power required is also low and can be ensured by the cold compressed air.

At high driving speeds, however, the cold air layer zone displaces the hot air layer zone upward, depending on the driving speed of the vehicle and air flowing into the air inlets, resulting in a flow of hot air outward through the air outlet openings.

### BRIEF DESCRIPTION OF THE DRAWINGS

An exemplary embodiment of this invention is depicted in the drawings and described in greater detail below.

FIG. 1 shows the drive unit from the side with the hot and cold air layers separated by a temperature interface, and

FIG. 2 is a top view of the drive unit in the installation space, showing the air inlet openings and air outlet openings.

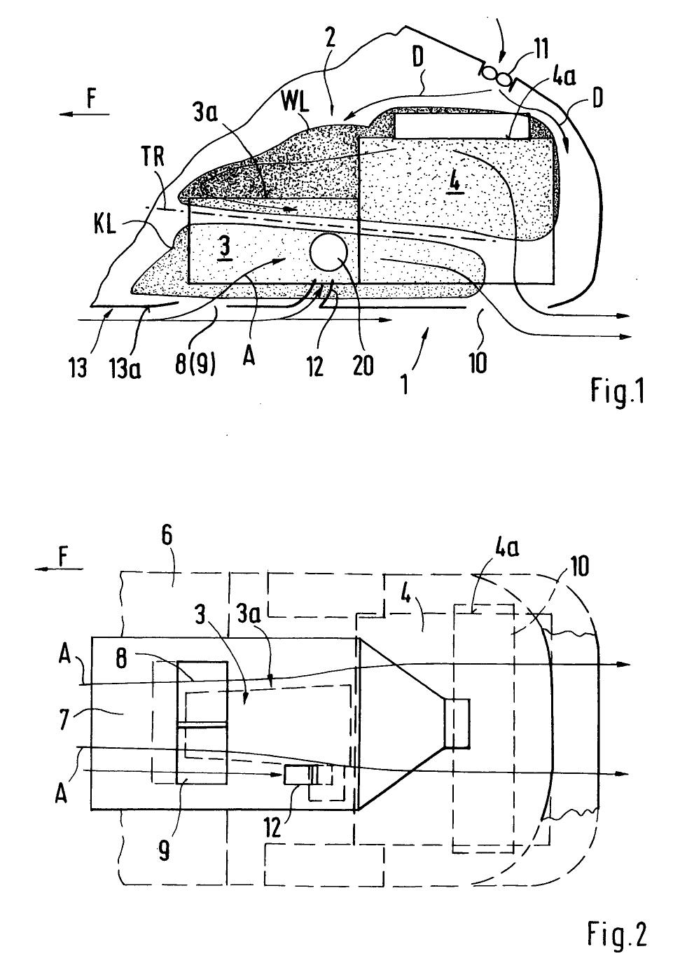

### DETAILED DESCRIPTION OF THE INVENTION

A cooling system 1 is provided for a drive unit 2, in particular for a drive unit mounted in the rear of a vehicle, comprising essentially a transmission 3 with an engine 4 connected directly to it.

The drive unit 2 is situated in an installation space 6, whereby the transmission 3, which is situated in a transmission case 3a, is at the front (as seen in the direction of travel F) and the engine 4, which is inside an engine housing 4a, is behind it. The drive unit 2 is covered toward the installation space 6 by a covering panel part 13a of the vehicle which forms an undercarriage 13.

In the front area of the transmission case 3a, the covering panel part 7 has air inlets 8, 9, which are designed to cover a broad area, and thus a slow-flow air movement can be created.

Air outlet openings 10 are provided in the area of the rear engine housing 4a or in a cover thereof. An intake fan 11 for supplying cold compressed air D into the installation space 6 is situated above the engine housing 4a.

To achieve a directed oncoming airflow in addition to the air supplied through the air inlets 8, 9, an oncoming flow channel 12 is formed in the area of a differential 20, for example, so that the air A flowing along the undercarriage 13 is supplied directly to the differential 20.

The air A entering through the air inlets 8, 9 in the covering panel part 13a creates a cold air layer zone KL which encompasses (with its outline as depicted here, for example) the transmission case 3a and the bottom part of the engine 4. Above this cold air layer zone KL, there is a hot air layer zone WL layered above it (the outline of which is also shown here as an example) due to the heat of the engine 4. Between these two air layer zones KL and WL, there is a so-called temperature interface TR which can temporarily shift the hot/cold temperature ratios up or down accordingly.

The cooling system 1 produces a slow-flow air movement over a large area, forming a two-zone pattern KL and WL. The environment of the units 3, 4 to be cooled is thereby brought to a lower temperature level over a large volume.

The size of the cold air layer zone KL also depends to a great extent on the driving speed of the vehicle. At low driving speeds, the flow through the scavenging air blower 11 is dominant, heat production in the transmission area is low and thus the required cooling power is also low. At high driving speeds of the vehicle with high transmission heat losses, however, the flow through the undercarriage openings 8, 9 is dominant. The cold air layer zone KL is expanded toward the top and thus displaces the hot air layer zone WL further upward. The hot air in this area is forced to leave the installation space 6 downward and toward the rear through openings 10 or through clearances in the body.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Cooling system for an automotive drive unit, in particular for a drive unit such as an internal combustion engine situated in a rear end of a vehicle with a respective transmission, comprising a covering panel part situated beneath the drive unit as part of a covering undercarriage of a vehicle superstructure, wherein a warmer air layer zone formed on an engine side is layered above oncoming air supplied to a transmission case through air inlets in the covering panel part of the undercarriage, forming a cold air layer zone, and wherein a temperature interface develops between the cold air and the warmer air layer zones, temporarily running approximately in an area of an upper border of the transmission case and through a lower partial area of an engine housing which is connected to the transmission case.

2. Cooling system as claimed in claim 1, wherein the air inlets are provided on a front side, as seen in a direction of travel, beneath the transmission case in the covering panel part of the undercarriage, and wherein air outlet openings are provided at the rear beneath the engine housing in an installation space.

3. Cooling system as claimed in claim 2, wherein the air inlets are provided in a front area beneath the transmission case over a large area in the covering panel part, and wherein the air outlet openings are provided in a rear area of the engine housing.

4. Cooling system as claimed in claim 1, wherein at least one additional air inlet opening, defining an oncoming flow channel, is provided behind the air inlets, as seen in a direction of travel, in the covering panel part of the undercarriage, and is directed at a differential of the transmission.

5. Cooling system as claimed in claim 1, and further comprising a scavenging air blower provided for the engine at the top in an installation space, and wherein said scavenging air blower has a compressed air inlet supply which acts upon the warmer air layer zone.

6. Cooling system as claimed in claim 2, wherein the cold air layer zone can be enlarged as a function of the driving speed of the vehicle and can increase in size upward due to air flowing into the installation space through the air inlets, displacing the hot air layer zone upward, and wherein an outward flow of hot air on the engine side through the air outlet openings can be achieved.

7. A process of operating a cooling system for an automotive drive unit, in particular for a drive unit such as an internal combustion engine situated in a rear end of a vehicle with a respective transmission, the system having a covering panel part situated beneath the drive unit as part of a covering undercarriage of a vehicle superstructure, comprising forming a warmer air layer zone on an engine side above oncoming air supplied to a transmission case through air inlets in the covering panel part of the undercarriage, forming a cold air layer zone, and developing a temperature interface between the cold air and the warmer air layer zones, temporarily running approximately in an area of an upper border of the transmission case and through a lower partial area of an engine housing which is connected to the transmission case.

8. The process as claimed in claim 7, wherein the air inlets are provided on a front side, as seen in a direction of travel, beneath the transmission case in the covering panel part of the undercarriage, and wherein air outlet openings are provided at the rear beneath the engine housing in an installation space.

9. The process as claimed in claim 8, wherein the air inlets are provided in a front area beneath the transmission case over a large area in the covering panel part, and wherein the air outlet openings are provided in a rear area of the engine housing.

10. Cooling system as claimed in claim 7, wherein at least one additional air inlet opening, defining an oncoming flow channel, is provided behind the air inlets, as seen in a direction of travel, in the covering panel part of the undercarriage, and is directed at a differential of the transmission.

11. The process as claimed in claim 7, wherein a scavenging air blower is provided for the engine at the top in an installation space, and wherein said scavenging air blower has a compressed air inlet supply which acts upon the warmer air layer zone.

12. The process as claimed in claim 8, wherein the cold air layer zone can be enlarged as a function of the driving speed of the vehicle and can increase in size upward due to air flowing into the installation space through the air inlets, displacing the hot air layer zone upward, and wherein an outward flow of hot air on the engine side through the air outlet openings can be achieved.

13. A vehicle including a cooling system and an automotive drive unit situated in a rear end of the vehicle comprising:
a transmission with a transmission case, and
a covering panel part situated beneath the drive unit as part of a covering undercarriage of a vehicle superstructure,
wherein a warmer air layer zone formed on an engine side is layered above oncoming air supplied to the transmission case through air inlets in the covering panel part of the undercarriage, forming a cold air layer zone, and
wherein a temperature interface develops between the cold air and the warmer air layer zones, running approximately in an area of an upper border of the transmission case and through a lower partial area of a drive unit housing which is connected to the transmission case.

14. The vehicle as claimed in claim 13, wherein the air inlets are provided on a front side, as seen in a direction of travel, beneath the transmission case in the covering panel part of the undercarriage, and wherein air outlet openings are provided at the rear beneath the drive unit housing in an installation space.

15. The vehicle as claimed in claim 14, wherein the air inlets are provided in a front area beneath the transmission case over a large area in the covering panel part, and wherein the air outlet openings are provided in a rear area of the drive unit housing.

16. The vehicle as claimed in claim 13, wherein at least one additional air inlet opening, defining an oncoming flow channel, is provided behind the air inlets, as seen in a direction of travel, in the covering panel part of the undercarriage, and is directed at a differential of the transmission.

17. The vehicle as claimed in claim 13, and further comprising a scavenging air blower provided for the drive unit at the top in an installation space, wherein said scavenging air blower has a compressed air inlet supply which acts upon the warmer air layer zone.

18. The vehicle as claimed in claim 14, wherein the cold air layer zone can be enlarged as a function of the driving speed of the vehicle and can increase in size upward due to air flowing into the installation space through the air inlets, displacing the hot air layer zone upward, and wherein an outward flow of hot air on the drive unit side through the air outlet openings can be achieved.

19. A process of cooling an automotive drive system mounted in a rear of a vehicle by way of air inlet openings provided in a covering panel part of an undercarriage, comprising:
creating, through an influx of air, a cold air layer zone around a transmission and a bottom of an engine, and
displacing a hot air layer zone of the engine, which is located above the cold air layer zone, outward through air outlets.
